(19) United States
(12) Patent Application Publication
(10) Pub. No.: US 2024/0275725 A1
(43) Pub. Date: Aug. 15, 2024

(54) CHANNEL SWITCHING METHOD, CHANNEL SWITCHING DEVICE, CHANNEL SWITCHING SYSTEM AND PROGRAM

(71) Applicant: NIPPON TELEGRAPH AND TELEPHONE CORPORATION, Tokyo (JP)

(72) Inventors: Toshihito FUJIWARA, Musashino-shi, Tokyo (JP); Satoshi NARIKAWA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/569,167

(22) PCT Filed: Jul. 1, 2021
(86) PCT No.: PCT/JP2021/025031

§ 371 Date: Dec. 11, 2023

(51) Int. Cl. H04L 47/122; H04L 47/193

(52) U.S. Cl. CPC H04L 47/122; H04L 47/193

(57) ABSTRACT

An object of the present disclosure is to provide a communication path switching method for improving a throughput of TCP communication at the time of switching a communication path between a first communication path that is at least one of a low latency or high speed and a second communication path that is at least one of a high latency or low speed.

The communication path switching method according to the present disclosure is a communication path switching method for switching a communication path to a first communication path or a second communication path by using operation of a TCP accelerator in a communication path switching system including a terminal that performs TCP communication by switching a communication path between the first communication path that is at least one of a low latency or high speed and the second communication path that is at least one of a high latency or low speed, the communication path switching method including: receiving data from the terminal; and when the data is first received after the communication path is switched from the first communication path to the second communication path, transmitting again to the terminal, an acknowledgement signal transmitted last before the communication path is switched.

### TECHNICAL FIELD

The present invention relates to a communication path switching method, a communication path switching device, a communication path switching system, and a program that improve a throughput of communication between terminals when a communication path is switched between communication paths having a difference in transmission speed.

### BACKGROUND ART

Transmission control protocol (TCP) has a congestion control function of adjusting a throughput according to a state of a communication path. It is known that this congestion control function is difficult to achieve an optimal throughput in a network with a high latency and a large packet loss.

To address this problem, a TCP accelerator is known as a method for improving a TCP throughput without changing a TCP algorithm of an end terminal. The TCP accelerator is installed in a network with a high latency and a large packet loss and achieves a high TCP throughput with respect to the high latency and packet loss by dividing a network that performs congestion control while transparently passing TCP communication and performing appropriate control for each network.

For example, in a network with a high latency, a throughput can be improved by widening a congestion window. For example, in a network with a large packet loss, by the TCP accelerator playing a role of retransmission control, it is possible to improve a throughput by making it difficult for a transmitter to detect the packet loss.

### CITATION LIST

### Non Patent Literature

Non Patent Literature 1: Wolf, Tilman, Shulin You, and Ramaswamy Ramaswamy. “Transparent TCP acceleration through network processing.” GLOBECOM'05. IEEE Global Telecommunications Conference, 2005. Vol. 2. IEEE, 2005.

### SUMMARY OF INVENTION

### Technical Problem

On the other hand, assuming a communication network in water, a network using, for example, sonic communication with a low speed and a high latency but high availability, or optical wireless communication in which an instantaneous communication interruption is likely to occur due to low diffraction but a high speed and a low latency, is considered as a communication medium.

Assuming a network in which a communication unit is switched between a low-speed and high-latency communication unit such as the sonic communication and a high-speed and low-latency communication unit such as the optical wireless communication as a redundant configuration, a scheme of switching the higher-speed and lower-latency communication unit that is mainly used to the low-speed and high-latency communication unit is conceivable.

If TCP is used in such a switching scheme, a packet loss hardly occurs, but a change in communication speed is large, and in addition, a delay state thereof frequently changes. In such a communication path, a packet loss does not occur and a state is not a steady high-latency state, and thus, there is a problem that congestion control of TCP cannot be performed, or a TCP accelerator in related art cannot achieve a sufficient TCP throughput with respect to a physical transmission capacity of the communication path.

In order to solve the above problem, an object of the present invention is to provide a communication path switching method, a communication path switching device, a communication path switching system, and a program that improve a throughput of TCP communication at the time of switching a communication path between a first communication path that is at least one of a low latency or high speed and a second communication path that is at least one of a high latency or low speed.

### Solution to Problem

In order to achieve the above object, the communication path switching method, the communication path switching device, the communication path switching system, and the program of the present disclosure cause a terminal to detect a packet loss in a pseudo manner by using operation of a TCP accelerator.

Specifically, a communication path switching method according to the present disclosure is a communication path switching method for switching a communication path to a first communication path or a second communication path by using operation of a TCP accelerator in a communication path switching system including a terminal that performs TCP communication by switching a communication path between the first communication path that is at least one of a low latency or high speed and the second communication path that is at least one of a high latency or low speed, the communication path switching method including:
receiving data from the terminal;
when the data is first received after the communication path is switched from the first communication path to the second communication path, transmitting again to the terminal, an acknowledgement signal transmitted last before the communication path is switched.

Specifically, a communication path switching device according to the present disclosure is a communication path switching device that switches a communication path to a first communication path or a second communication path by using operation of a TCP accelerator in a communication path switching system including a terminal that performs TCP communication by switching a communication path between the first communication path that is at least one of a low latency or high speed and the second communication path that is at least one of a high latency or low speed, the communication path switching device including:
a data reception unit configured to receive data from the terminal; and
a TCP termination unit configured to, when the data reception unit first receives the data after the communication path is switched from the first communication path to the second communication path, transmit again to the terminal, an acknowledgement signal transmitted last before the communication path is switched.

Specifically, a communication path switching system according to the present disclosure includes:
the communication path switching device, the first communication path, the second communication path, and the terminal.

Specifically, a program according to the present disclosure causes a computer to function as the communication path switching device.

The communication path switching method, the communication path switching device, the communication path switching system, and the program of the present disclosure can improve a throughput of TCP communication at the time of switching a communication path between the first communication path that is at least one of a low latency or high speed and the second communication path that is at least one of a high latency or low speed by causing the terminal to detect a packet loss in a pseudo manner by using operation of the TCP accelerator.

Note that the inventions described above can be combined in any possible manner.

### Advantageous Effects of Invention

According to the present disclosure, it is possible to provide a communication path switching method, a communication path switching device, a communication path switching system, and a program that improve a throughput of TCP communication at the time of switching a communication path between a first communication path that is at least one of a low latency or high speed and a second communication path that is at least one of a high latency or low speed.

### BRIEF DESCRIPTION OF DRAWINGS

FIG. 1 illustrates an example of a schematic configuration of a communication path switching system according to the present invention.

FIG. 2 illustrates an example of a schematic configuration of a communication path switching and TCP congestion control termination device according to the present invention.

FIG. 3 illustrates an example of a schematic configuration of a communication path switching device according to the present invention.

FIG. 4 illustrates an example of operation of the communication path switching system according to the present invention.

FIG. 5 is a view illustrating a program according to the present disclosure.

### DESCRIPTION OF EMBODIMENTS

Hereinafter, embodiments of the present disclosure will be described in detail with reference to the drawings. Note that the present invention is not limited to the embodiments described below. These embodiments are merely examples, and the present disclosure can be implemented in a form with various modifications and improvements based on the knowledge of those skilled in the art. Components with the same reference numerals in the present specification and the drawings denote the same components.

### First Embodiment

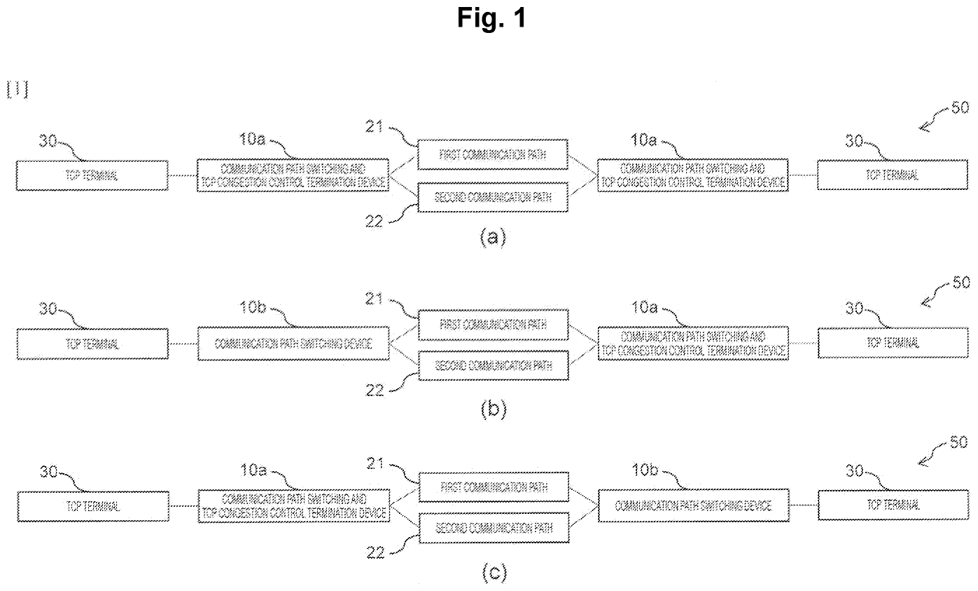

FIGS. 1(a), 1(b), and 1(c) illustrate an example of a schematic configuration of a communication path switching system 50 according to the present embodiment. The communication path switching system 50 includes a first communication path 21, a second communication path 22, and a terminal 30. In addition, the communication path switching system 50 includes at least one of a communication path switching and TCP congestion control termination device 10a or a communication path switching device 10b.

The first communication path 21 is a communication path with a low latency or high speed, or a communication path with a low latency and high speed. For example, optical wireless communication may be used.

The second communication path 22 is a communication path with a high latency or low speed, or a communication path with a high latency and low speed. For example, sonic communication may be used. The second communication path 22 may be a redundant communication path of the first communication path 21, and the first communication path 21 may be preferentially used rather than the second communication path 22. Note that the communication path switching system 50 may include three or more communication paths.

The terminals 30 perform TCP communication via the first communication path 21 or the second communication path 22. Hereinafter, a terminal that performs TCP communication is referred to as a TCP terminal 30.

The communication path switching device 10b is connected to one end of each of the first communication path 21 and the second communication path 22, monitors the first communication path 21 and the second communication path 22 and switches the communication path between them as described later.

The communication path switching and TCP congestion control termination device 10a is obtained by adding a function of terminating the TCP congestion control to the communication path switching device 10b. Here, the function of terminating the TCP congestion control is a function of transmitting an acknowledgement signal (ACK) at the time of data reception or a duplicate acknowledgement signal (duplicate ACK) at the time of occurrence of a packet loss to the TCP terminal 30 that has transmitted the data, instead of the TCP terminal 30 that receives the data. As a device having a function of terminating TCP congestion control, a TCP accelerator can be exemplified. The TCP congestion control termination function of the communication path switching and TCP congestion control termination device 10a can quickly shift control to control according to characteristics of the path by using information on communication path switching and can also perform control suitable for a transient state of the shift.

As illustrated in FIGS. 1(a) to 1(c), the communication path switching system 50 may include the communication path switching and TCP congestion control termination device 10a at both ends of the first communication path 21 and the second communication path 22 or may include the communication path switching and TCP congestion control termination device 10a at one end and include the communication path switching device 10b at the other end. In addition, the communication path switching system 50 may include the communication path switching and TCP congestion control termination device 10a or the communication path switching device 10b only at one end of the first communication path 21 and the second communication path 22. In this case, the communication path switching system 50 desirably includes the communication path switching and TCP congestion control termination device 10a or the communication path switching device 10b at one end of the first communication path 21 and the second communication path 22 on the TCP terminal 30 side serving as a transmitter.

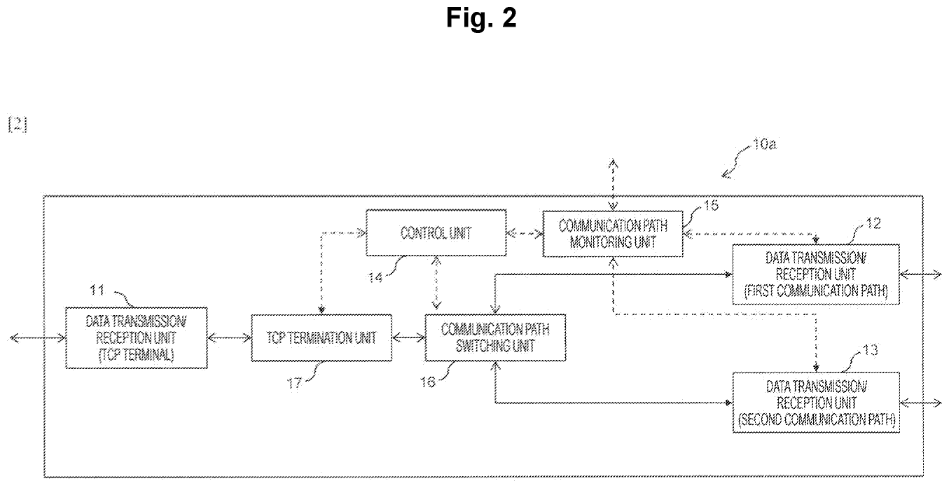

FIG. 2 illustrates a configuration of the communication path switching and TCP congestion control termination device 10a according to the present embodiment. The communication path switching and TCP congestion control termination device 10a according to the present embodiment includes: a data transmission/reception unit 11 (TCP terminal) having reachability over the TCP terminal; a data transmission/reception unit 12 (first communication path) connected to the first communication path 21 or having reachability over the first communication path 21; a data transmission/reception unit 13 (second communication path) connected to the second communication path 22 or having reachability over the second communication path 22; a communication path switching unit 16 that switches the communication path between the data transmission/reception unit 12 (first communication path) and the data transmission/reception unit 13 (second communication path); a TCP termination unit 17 that is connected to both the data transmission/reception unit 11 (TCP terminal) and the communication path switching unit 16 and terminates the passing TCP communication; a communication path monitoring unit 15 that monitors a communication state and a communication path state of the data transmission/reception unit 12 (first communication path) and the data transmission/reception unit 13 (second communication path) directly or indirectly in cooperation with an external system; and a control unit 14 that controls the communication path switching unit 16 and the TCP termination unit 17 on the basis of information of the communication path monitoring unit 15.

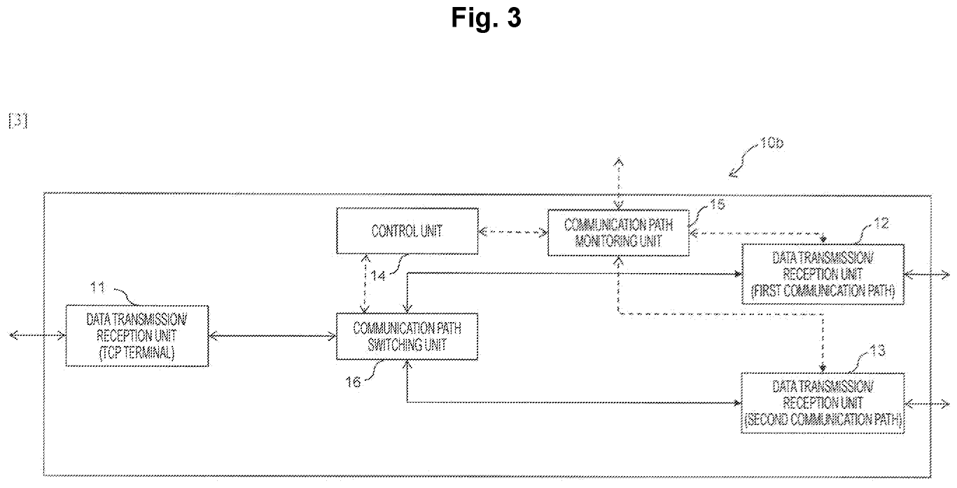

FIG. 3 illustrates a configuration of the communication path switching device 10b according to the present embodiment. In the communication path switching device 10b according to the present embodiment, the data transmission/reception unit 11 (TCP terminal) and the communication path switching unit 16 are directly connected in a form in which the TCP termination unit 17 is removed from the communication path switching device 10a.

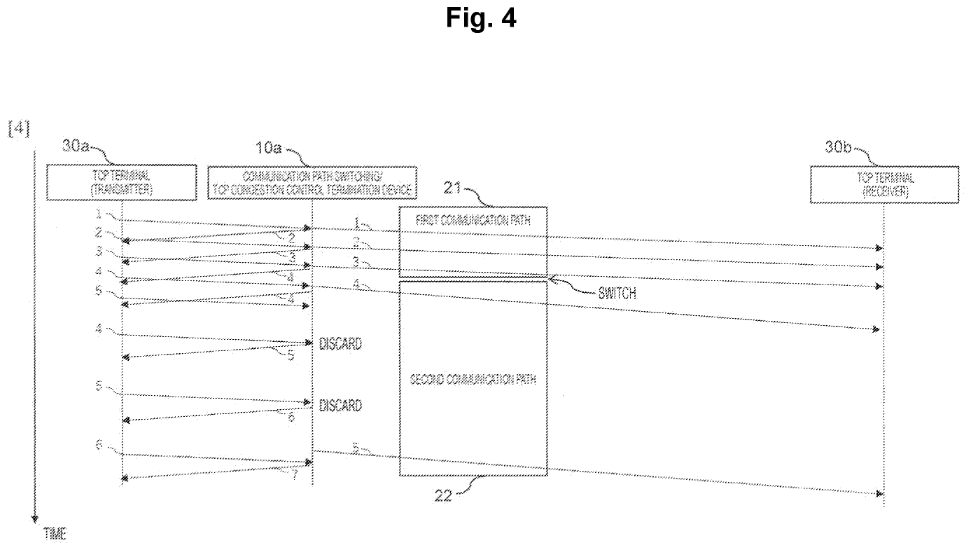

Operation of the communication path switching system 50 and the communication path switching device 10 according to the present embodiment will be described with reference to FIG. 4.

FIG. 4 is a sequence diagram illustrating operation when the TCP terminals 30 performing TCP communication using the first communication path 21 switch the communication path to the second communication path 22 halfway and perform TCP communication in the communication path switching system 50. Hereinafter, the TCP terminal 30 that transmits data is referred to as a transmitter 30a, and the TCP terminal 30 that receives data is referred to as a receiver 30b. Note that the transmitter 30a may further include a function of the receiver 30b. Furthermore, the receiver 30b may further include a function of the transmitter 30a.

The communication path switching and TCP congestion control termination device 10a whose operation is illustrated in FIG. 4 is installed between the transmitter 30a and the first communication path 21 and the second communication path 22 in the communication path switching system 50.

In FIG. 4, a number of an arrow line from the transmitter 30a to the communication path switching and TCP congestion control termination device 10a represents a sequence number of data to be transmitted by the transmitter 30a. In FIG. 4, a number of an arrow line from the communication path switching and TCP congestion control termination device 10a to the transmitter 30a represents an acknowledgement number for data to be transmitted by the transmitter 30a. A number of an arrow line from the communication path switching and TCP congestion control termination device 10a to the receiver 30b represents a sequence number of data to be transmitted from the communication path switching and TCP congestion control termination device 10a to the receiver 30b.

In FIG. 4, a state in which the transmitter 30a and the receiver 30b communicate using the first communication path 21 is represented by the arrow line from the communication path switching and TCP congestion control termination device 10a to the receiver 30b passing through the first communication path 21. Similarly, in FIG. 4, a state in which the transmitter 30a and the receiver 30b communicate using the second communication path 22 is represented by the arrow line from the communication path switching and TCP congestion control termination device 10a to the receiver 30b passing through the second communication path 22.

The communication path monitoring unit 15 monitors the first communication path 21 and the second communication path 22 directly using the data transmission/reception unit 12 (first communication path) and the data transmission/reception unit 13 (second communication path), or indirectly using an external system. For example, the communication path monitoring unit 15 may monitor a physical state of each communication path by using the data transmission/reception unit 12 (first communication path) and the data transmission/reception unit 13 (second communication path) or may transmit an alive monitoring signal of the communication path and monitor the signal in order to quickly detect a communication/disconnection state of the communication path.

In particular, by directly monitoring the data transmission/reception unit 12 (first communication path) directly connected to the first communication path 21 or the data transmission/reception unit 13 (second communication path) directly connected to the second communication path 22, it is possible to detect a communication state or a disconnection state of each communication path without delay. As a result, operation of the communication path switching unit and processing in the TCP termination unit 17 described later can be performed without delay, so that it is possible to enhance an effect of the present system.

In order to detect a delay state of the communication path, the communication path monitoring unit 15 may transmit a response request signal to each communication path and receive an acknowledgement signal based on the response request signal, acquire a round-trip delay period from transmission time of the above-described response request signal and reception time of the acknowledgement signal based on the response request signal and obtain a delay period of the communication path. In a case where the communication path monitoring unit 15 receives the response request signal, the communication path monitoring unit 15 may transmit an acknowledgement signal based on the response request signal.

In FIG. 4, for data with the sequence numbers 1 to 3, normal TCP communication is performed from the transmitter 30a to the receiver 30b. Specifically, it may be performed as follows.

The transmitter 30a transmits data with sequence numbers to the receiver 30b. In FIG. 4, the sequence numbers of the data to be transmitted by the transmitter 30a are set starting from 1. Transmission speed of the transmitter 30a is desirably controlled by TCP congestion control. For example, in a case where a duplicate ACK is received, the transmitter 30a may reduce the transmission speed by determining that a packet loss is detected. The reduction in the transmission speed is to reduce an amount of data to be transmitted per unit time, and for example, a data transmission interval of the transmitter 30a may be increased, an amount of data per transmission of the transmitter 30a may be reduced, or both may be performed. In the present embodiment, the data transmission interval of the transmitter 30a is increased to reduce the transmission speed.

The data transmission/reception unit 11 (TCP terminal) receives data from the transmitter 30a.

The TCP termination unit 17 stores the data received by the data transmission/reception unit 11 (TCP terminal).

In a case where the data received by the data transmission/reception unit 11 (TCP terminal) is already stored, the TCP termination unit 17 may discard the received data.

The data transmission/reception unit 12 (first communication path) or the data transmission/reception unit 13 (second communication path) transmits the data stored in the TCP termination unit 17 to the receiver 30b. The data transmission/reception unit 12 (first communication path) or the data transmission/reception unit 13 (second communication path) desirably transmits data to the receiver 30b without delay. Furthermore, the transmission may be performed in accordance with a reception timing of the receiver 30b.

The TCP termination unit 17 transmits an acknowledgement signal (ACK) to which an acknowledgement number is assigned to the transmitter 30a when the data transmission/reception unit 11 (TCP terminal) receives data. The acknowledgement number may be a number obtained by adding a data size of the received data to the sequence number. In the present embodiment, as illustrated in FIG. 4, a sequence number obtained by adding 1 to the sequence number is set as an acknowledgement number, but the present invention is not limited thereto.

Next, a case where the transmitter 30a transmits data with the sequence number 4 and subsequent data, that is, a case where the transmitter 30a and the receiver 30b perform TCP communication using the second communication path 22 will be described. In the present embodiment, a case where the communication path is switched from the first communication path 21 to the second communication path 22 after the communication path switching and TCP congestion control termination device 10a receives the data with the sequence number 3 and before receiving the data with the sequence number 4 will be described.

In a case where it is detected that the first communication path 21 becomes unavailable, or the like, on the basis of the monitoring result of the communication path monitoring unit 15 under the control of the control unit 14, the communication path switching unit 16 switches the communication path to be used by the transmitter 30a and the receiver 30b from the first communication path 21 to the second communication path 22. In a case where the first communication path 21 is available, the communication path switching unit 16 may preferentially switch the communication path to the first communication path 21.

Switching from the first communication path 21 to the second communication path 22 may be performed by another device.

After the communication path is switched from the first communication path 21 to the second communication path 22 under the control of the control unit 14, when the data transmission/reception unit 11 (TCP terminal) first receives data from the transmitter 30a, the TCP termination unit 17 transmits to the transmitter 30a again, an acknowledgement signal transmitted last before the communication path is switched from the first communication path 21 to the second communication path 22. In FIG. 4, an acknowledgement number of the last transmitted acknowledgement signal before the communication path is switched from the first communication path 21 to the second communication path 22 is 4, and thus, the acknowledgement signal with the acknowledgement number 4 is transmitted to the transmitter 30a again when the data with the sequence number 4 is received from the transmitter 30a. This acknowledgement signal may be a selective acknowledgement signal (SACK). As a result, the TCP termination unit 17 causes the transmitter 30a to detect occurrence of a packet loss in a pseudo manner.

In a case where the transmitter 30a continuously receives duplicate acknowledgement signals twice, the transmitter 30a may retransmit data having the same sequence number as the acknowledgement number of the duplicate acknowledgement signal assuming that occurrence of a packet loss is detected, and reduce the transmission speed. In FIG. 4, the transmitter 30a has continuously received the acknowledgement signal with the acknowledgement number 4 twice, and thus, after the second reception of the acknowledgement signal with the acknowledgement number 4, the transmitter retransmits the data starting from the data with the sequence number 4 again with a transmission interval. In a case where the transmitter 30a receives a selective acknowledgement signal, the transmitter 30a may retransmit only data having the same sequence number as the acknowledgement number indicated in the selective acknowledgement signal.

Note that, in the present embodiment, a case where reception is continuously performed twice will be described, but the present invention is not limited thereto. For example, the transmitter 30a may detect that a packet loss has occurred in a case where the duplicate acknowledgement signals are continuously received three times. In this case, the transmitter 30a may transmit the data without decreasing the transmission speed until the duplicate acknowledgement signals are continuously received three times. In addition, after the communication path is switched from the first communication path 21 to the second communication path 22, the TCP termination unit 17 may transmit to the transmitter 30a, an acknowledgement signal transmitted last before the communication path is switched from the first communication path 21 to the second communication path 22 when data is first received from the transmitter 30a and when data is received next. As described above, the TCP termination unit 17 may transmit the acknowledgement signal transmitted last before the communication path is switched from the first communication path 21 to the second communication path 22 continuously a plurality of times from the time when the data is first received from the transmitter 30a after the communication path is switched from the first communication path 21 to the second communication path 22 according to the number of times of duplication of the acknowledgement signal in which the transmitter 30a detects occurrence of a packet loss.

In addition, even if the communication path is switched from the first communication path 21 to the second communication path 22, the TCP termination unit 17 can repeat transmission of the duplicate acknowledgement signal to the transmitter 30a and a normal non-duplicate acknowledgement signal within a range of an amount of data that can be stored in the TCP termination unit 17.

The TCP termination unit 17 transmits the duplicate acknowledgement signal to the transmitter 30a after the communication path is switched from the first communication path 21 to the second communication path 22, and thus, the data transmission/reception unit 11 (TCP terminal) duplicately receives the data already received from the transmitter 30a. Thus, the TCP termination unit 17 may discard the received duplicate data as described above.

In FIG. 4, the transmitter 30a transmits the data up to the sequence number 5 before the second reception of the acknowledgement signal with the acknowledgement number 4, and thus, the data up to the sequence number 5 is stored in the TCP termination unit 17 before the transmitter 30a retransmits the data with the sequence number 4 and subsequent data. For the data with the sequence numbers 4 and 5 retransmitted by the transmitter 30a, the data with the sequence number 4 has been transmitted to the receiver 30b and the data with the sequence number 5 has already been stored in the TCP termination unit 17, and thus, the TCP termination unit 17 may discard the data with sequence numbers 4 and 5 received again. Note that the TCP termination unit 17 may store the data transmitted to the receiver 30b in preparation for a packet loss in the second communication path 22. Then, when the duplicate acknowledgement signal is received from the receiver 30b, the communication path switching and TCP congestion control termination device 10a may transmit data having the same sequence number as the acknowledgement number of the duplicate acknowledgement signal to the receiver 30b again.

Note that, also in a case where the data reception unit 11 receives the data with the sequence numbers 4 and 5 again, the TCP termination unit 17 transmits the acknowledgement signals (the acknowledgement signals with the acknowledgement numbers 5 and 6 in FIG. 4) as described above.

In addition, the data transmission/reception unit 12 (first communication path) or the data transmission/reception unit 13 (second communication path) may transmit the data stored in the TCP termination unit 17 to the receiver 30b in accordance with a data retransmission timing of the transmitter 30a. For example, in the data transmission/reception unit 12 (first communication path) or the data transmission/reception unit 13 (second communication path), although the data transmission/reception unit 11 (TCP terminal) receives the data with the sequence number 5 again, this may be discarded, and the data with the sequence number 5 stored in the TCP termination unit 17 may be transmitted to the receiver 30b. Note that the present invention is not limited thereto, and the data transmission/reception unit 12 (first communication path) or the data transmission/reception unit 13 (second communication path) may transmit the data stored in the TCP termination unit 17 to the receiver 30b without delay.

Part of the acknowledgement signal from the TCP termination unit 17 for the data transmitted from the transmitter 30a may be omitted.

The receiver 30b returns an acknowledgement signal for the received data to the transmitter 30a, but the communication path switching and the TCP congestion control termination device 10a terminates the TCP congestion control. The communication path switching and TCP congestion control termination device 10a can transfer the acknowledgement signal to the transmitter 30a only in a case where data retransmission is required. Note that in FIG. 4, the acknowledgement signal from the receiver 30b is omitted.

The communication path switching device 10 of the present invention can also be implemented by a computer and a program, and the program can be recorded in a recording medium or provided through a network.

As described above, according to the present disclosure, it is possible to provide a communication path switching method, a communication path switching device, a communication path switching system, and a program that improve a throughput of TCP communication at the time of switching a communication path between a first communication path that is at least one of low latency or high speed and a second communication path that is at least one of high latency or low speed by causing a terminal to detect a packet loss in a pseudo manner using operation of a TCP accelerator.

According to the present disclosure, at the time of switching a communication path from the first communication path to the second communication path, the throughput of the transmitter can be adapted to low communication path speed, so that it is possible to prevent a packet loss, or the like. As a result, a physical transmission capacity of the communication path can be efficiently used, so that it is possible to improve the throughput.

Furthermore, according to the present disclosure, in a case where the first communication path is a main communication path and the second communication path is a redundant communication path, when the main communication path is not in operation, communication can be continued by switching the communication path to the redundant communication path.

It is possible to implement redundant communication of a communication path by a sound wave and an electromagnetic wave such as optical radio in water and to provide communication utilizing characteristics favorable for communication of both high speed of optical radio and reachability of the sound wave (communication operation rate).

### Second Embodiment

The communication path switching device 10 can also be implemented by a computer and a program, and the program can be recorded in a recording medium or provided through a network.

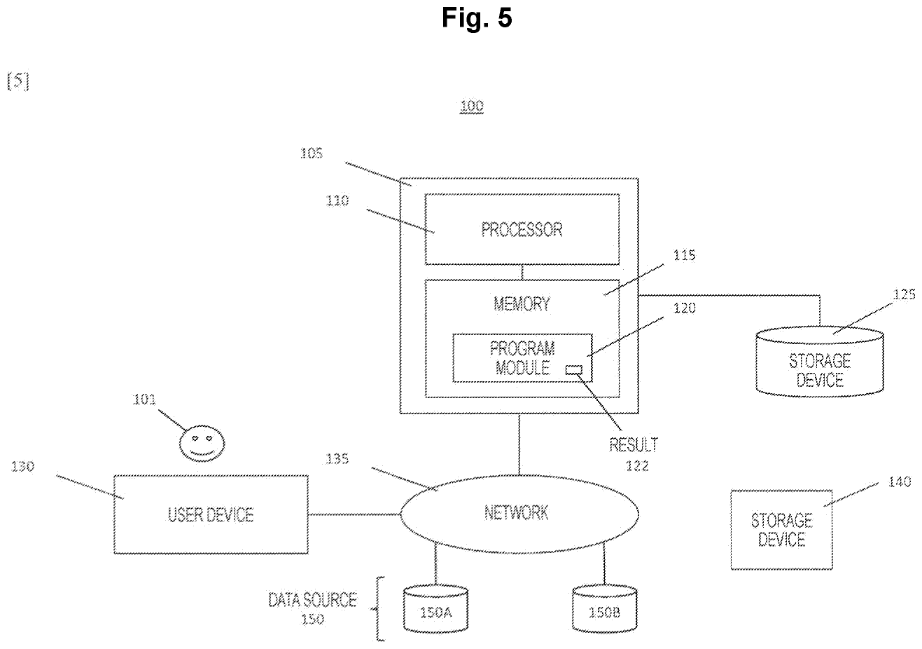

FIG. 5 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by an electronic signal and an optical signal via the network 135.

The computer 105 includes a processor 110 and a memory 115 connected to the processor 110. In the present specification, the computer 105 is represented as a standalone device. On the other hand, the computer is not limited thereto, and may be connected to other devices (not illustrated) in a distributed processing system.

The processor 110 is an electronic device including a logic circuitry that responds to a command and executes the command.

The memory 115 is a tangible computer-readable storage medium in which a computer program is encoded. In this regard, the memory 115 stores data and commands, that is, program codes, that are readable and executable by the processor 110 to control operation of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to perform processes described in the present specification. In the present specification, although it is described that operation is executed by the computer 105, a method, a process, or a sub-process thereof, the operation is actually executed by the processor 110.

In the present specification, the term “module” is used to refer to functional operation that may be embodied one of as a stand-alone component or as an integrated configuration of a plurality of sub-components. Thus, the program module 120 can be implemented as a single module or as a plurality of modules that operate in cooperation with each other. Further, in the present specification, although the program module 120 is described as being installed in the memory 115 and thus implemented in software, the program module 120 can be implemented in any of hardware (for example, an electronic circuit), firmware, software, or a combination thereof.

Although the program module 120 is illustrated as already being loaded into the memory 115, the program module 120 may be configured to be provided on a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device provided in a remote storage system (not illustrated) and connected to the computer 105 via the network 135. The system 100 further includes a data source 150A and a data source 150B which are collectively referred to herein as a data source 150 and are communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide the output to a storage device 125 such as a database or a memory or to a remote device (not illustrated) via the network 135.

For example, a program for performing the operation of the communication path switching and TCP congestion control termination device 10a illustrated in FIG. 4 may be used as the program module 120. The system 100 can be operated as the communication path switching device 10.

The term “include . . . ” or “including . . . ” specifies that the mentioned features, integers, steps, or components are present, but should be understood as not excluding the presence of one or more other features, integers, steps, or components, or groups thereof. The terms “a” and “an” are indefinite articles for an object and therefore do not exclude embodiments including a plurality of objects.

### Other Embodiments

Note that the present invention is not limited to the above embodiments, and various modifications can be made without departing from the gist of the present invention. In short, the present invention is not limited to the specific embodiments, and in the implementation stage, the components may be modified and embodied without departing from the scope of the present invention.

In addition, various inventions can be made by appropriately combining a plurality of components disclosed in the above embodiments. For example, some components may be deleted from all the components illustrated in the embodiments. Further, components in different embodiments may be appropriately combined.

Note that the inventions described above can be combined in any possible manner.

### INDUSTRIAL APPLICABILITY

The communication path switching method, the communication path switching device, the communication path switching system, and the program according to the present disclosure can be applied to an information communication industry.

### REFERENCE SIGNS LIST

10 Communication path switching device
11 Data transmission/reception unit (TCP terminal)
12 Data transmission/reception unit (first communication path)
13 Data transmission/reception unit (second communication path)
14 Control unit
15 Communication path monitoring unit
16 Communication path switching unit
17 TCP termination unit
21 First communication path
22 Second communication path
30 Terminal
30a Transmitter
30b Receiver
50 Communication path switching system
100 System
101 User
105 Computer
110 Processor
115 Memory
120 Program module
122 Result
125 Storage device
130 User device
135 Network
140 Storage device
150 Data source

1. A communication path switching method for switching a communication path to a first communication path or a second communication path by using operation of a TCP accelerator in a communication path switching system including a terminal that performs TCP communication by switching a communication path between the first communication path that is at least one of a low latency or high speed and the second communication path that is at least one of a high latency or low speed, the communication path switching method comprising:
receiving data from the terminal;
when the data is first received after the communication path is switched from the first communication path to the second communication path, transmitting again to the terminal, an acknowledgement signal transmitted last before the communication path is switched.

2. A communication path switching device that switches a communication path to a first communication path or a second communication path by using operation of a TCP accelerator in a communication path switching system including a terminal that performs TCP communication by switching a communication path between the first communication path that is at least one of a low latency or high speed and the second communication path that is at least one of a high latency or low speed, the communication path switching device comprising:
a data reception unit configured to receive data from the terminal; and
a TCP termination unit configured to, when the data reception unit first receives the data after the communication path is switched from the first communication path to the second communication path, transmit again to the terminal, an acknowledgement signal transmitted last before the communication path is switched.

3. A communication path switching system comprising: the communication path switching device according to claim 2; the first communication path; the second communication path; and the terminal.

4. A program for causing a computer to function as the communication path switching device according to claim 2.
